(19) United States
(12) Patent Application Publication
(10) Pub. No.: US 2017/0230735 A1
(43) Pub. Date: Aug. 10, 2017

(54) Sensor Module with at Least One Interface

(71) Applicant: Robert Bosch GmbH, Stuttgart (DE)

(72) Inventors: Joachim Schadow, Stuttgart (DE); Manfred Lutz, Filderstadt (DE); Anna Heszler, Schwieberdingen (DE); Joern Stock, Wernau (DE); Cornelius Boeck, Kirchheim (DE); Joerg Maute, Sindelfingen (DE); Florian Esenwein, Leinfelden-Echterdingen (DE); Daniel Barth, Leinfelden-Echterdingen (DE); Christoph Steurer, Urbach (DE)

(21) Appl. No.: 15/501,054

(22) PCT Filed: Jun. 2, 2015
(86) PCT No.: PCT/EP2015/062259

§ 371 Date: Feb. 1, 2017

(30) Foreign Application Priority Data
Aug. 6, 2014 (DE) 10 2014 215 504.5

(51) Int. Cl. H04Q 9/00; G01D 11/30; G01D 7/00

(52) U.S. Cl. CPC H04Q 9/00; G01D 7/00; G01D 11/30

(57) ABSTRACT

In one embodiment, a sensor module is configured to be used in a system. The sensor module includes a sensor. The sensor can detect and convert at least one parameter to be determined into a sensor signal. The sensor module also includes a communication module that can establish a data transmission connection. The sensor module also includes a power supply unit that can supply the sensor module with electrical power. The sensor module further includes a mechanical interface. The sensor module can be connected to external application units using the mechanical interface.

The invention relates to a sensor module having at least one interface.

### PRIOR ART

Sensor modules that detect a property to be determined and convert said property into a sensor signal are known from the prior art. Said sensor modules are permanently installed in an external application. This has the disadvantage that the sensor module is disposed of when the application reaches the end of its life.

### DISCLOSURE OF THE INVENTION

In contrast, the sensor module according to the invention having the features of the independent claim has the advantage that it can be connected in particular detachably to various external application units. In this context, “can be connected detachably” shall be understood to mean in particular that the sensor module can be connected to an external application unit but can be disconnected again non-destructively.

The sensor module advantageously comprises at least one sensor that is designed to detect and convert into at least one sensor signal at least one property. The sensor can advantageously be implemented at least as one of the following sensor applications: as a displacement sensor, an accelerometer, a motion detector, a yaw-rate sensor, a pressure sensor, an air-pressure sensor, a humidity sensor, a gas sensor, an attitude sensor, a light sensor, a proximity sensor, an acoustic sensor, a temperature sensor, a magnetic field sensor, a positioning sensor or the like.

A displacement sensor, for example, is a radar or an ultrasound sensor, and is used to measure the distance between an object and a reference point. In this case, the change in the distance is converted into a sensor signal. If the sensor comprised by the sensor module is a displacement sensor, the distance between the sensor module and a reference point in the surrounding area is measured and converted into a sensor signal.

An accelerometer is a sensor that measures its acceleration. If the sensor comprised by the sensor module is an accelerometer, the accelerations acting on the sensor module are measured and converted into a sensor signal.

A motion detector is an electronic sensor that detects movements in its immediate environment and can thereby work as an electrical switch. If the sensor comprised by the sensor module is a motion detector, then movements in the environment of the sensor module are detected and converted into a sensor signal.

Yaw-rate sensors measure the angular acceleration of a body. If the sensor comprised by the sensor module is a yaw-rate sensor, then angular accelerations of the sensor module are measured and converted into a sensor signal.

A pressure sensor measures a force. If the sensor comprised by the sensor module is a pressure sensor, the force acting on a measurement surface of the sensor of the sensor module is measured and converted into a sensor signal.

An air-pressure sensor measures an air pressure. If the sensor comprised by the sensor module is an air pressure, . . . .

One type of humidity sensor is used, for example, to measure the soil moisture continuously. If the sensor comprised by the sensor module is a humidity sensor, the soil moisture in the environment of the sensor module, which lies close to the soil, is measured and converted into a sensor signal.

A gas sensor is a sensor designed to detect gaseous substances. For instance, it can be used advantageously to detect too high a concentration of smoke or CO2. If the sensor comprised by the sensor module is a gas sensor, the production of smoke, gases or CO2 in the environment of the sensor module is measured and converted into a sensor signal.

An attitude sensor is used to determine the orientation and position. It can be used advantageously to determine the spatial orientation and/or position. If the sensor comprised by the sensor module is an attitude sensor, then the orientation and/or position of the sensor module is measured and converted into a sensor signal.

A light sensor uses the photoelectric effect to convert visible and/or invisible light, for instance UV or infrared light, into an electrical signal. If the sensor comprised by the sensor module is a light sensor, the light radiation in the environment of the sensor module is measured and converted into a sensor signal.

Proximity sensors are contactless sensors i.e. they respond to the approach of an object without coming into direct contact. They are used, for example, for detecting the position of workpieces and tools, and as a trigger mechanism for safety measures.

An acoustic sensor converts acoustic signals into electrical signals such as a voltage, for example. If the sensor comprised by the sensor module is an acoustic sensor, acoustic signals in the environment of the sensor module are measured and converted into a sensor signal.

Temperature sensors measure a temperature and convert the value of the temperature into an electrical signal, for instance into a voltage. If the sensor comprised by the sensor module is a temperature sensor, a temperature of the sensor module is measured and converted into a sensor signal.

Magnetic field sensors measure a magnetic field strength and convert the measured value into an electrical signal.

Positioning sensors measure a position property and convert this property into a sensor signal. If the sensor comprised by the sensor module is a GPS sensor, the position of the sensor module is determined and converted into a sensor signal.

At least one electrical interface is provided for sending the sensor signal to at least one external open-loop and/or closed-loop control unit and/or to an external data processing unit. An “external open-loop and/or closed-loop control unit” shall be understood to mean a component unit that is arranged outside the sensor module and is intended to provide or to control by open-loop or closed-loop means a function of the external application unit on the basis of the sensor signal.

In an advantageous embodiment, the electrical interface comprises at least one combination male connector. The male connector is advantageously in the form of a circular combination male connector. In another advantageous embodiment, the male connector is in the form of a rectangular combination male connector. The combination male connector advantageously comprises at least one of the following connections:
Power supply connection
GPS antenna connection
Bluetooth connection
WLAN connection
Connections for digital signal transmission
Sensor connections
Connection for coding

The male connector can be in the form of a flat male connector. Other embodiments considered practical by a person skilled in the art are also possible, however.

In another advantageous embodiment, the electrical interface comprises individual male connectors. The functions of the electrical interface can thus be implemented using less space in particular when the functionality required is less than that provided by a combination male connector.

The electrical interface advantageously comprises coding for identifying the external application unit. In this case, the sensor module can advantageously use the coding to determine an external application unit. The external application unit can advantageously be provided with a resistor or the like which is identified by the sensor module. Functions can hence advantageously be enabled that may differ from one application unit to another.

The sensor module advantageously comprises at least one communications module for establishing a data transmission connection. Data can thus be transmitted advantageously from the sensor module to an external data processing unit. A “communications module” shall be understood to mean in particular a component that allows data transmission from the sensor module to an external data processing unit.

The communications module is preferably designed to be a wireless communications module. In this case, the communications module can be in the form of a WLAN communications module, a Bluetooth communications module, a radio communications module, an RFID communications module, an NFC communications module, an infrared communications module, a cellular network communications module or the like. The communications module is advantageously designed for bidirectional data transmission. In an alternative embodiment, the communications module is designed to be a wired communications module such as a LAN communications module, a USB communications module or the like, for example.

The “external data processing unit” can be implemented as a data processing unit integrated in a body, i.e. as a data processing unit such as an implant, for instance, integrated in a body of a user. The external data processing unit, however, can also be embodied as a smartphone, a personal computer, a laptop, a netbook, a tablet, a portable power tool, an output unit such as a loudspeaker, for example, as work clothing, safety goggles, a safety helmet or as another external data processing unit considered practical by a person skilled in the art. In an embodiment as a smartphone, a personal computer, a laptop, a netbook or a tablet, preferably an app for communicating with the communications module is provided. This can advantageously facilitate transmission of electronic data.

At least one power supply unit is advantageously provided for supplying the sensor module in particular with electrical power. The power supply unit is preferably in the form of a rechargeable battery. The rechargeable battery can preferably be recharged by means of a charging interface.

It is proposed that the sensor module comprises at least one mechanical interface, via which the sensor module can be connected in particular detachably to various external application units.

The mechanical interface is preferably implemented as a clip, a bayonet catch, a slideway, a screw coupling, a hook-and-loop fastener or the like, in order to produce an interlocking connection to an external application unit. It is also possible, however, to implement the mechanical interface in a different embodiment considered practical by a person skilled in the art.

In another advantageous embodiment, the mechanical interface is implemented as a bonded connection, for example as an adhesive bond.

In another advantageous embodiment, the mechanical interface provides a force-fit connection to an external application unit, for example by means of magnetic holding forces or friction forces.

Advantageous developments of the sensor module as claimed in claim 1 can be obtained from the features defined in the dependent claims.

At least one of said sensors advantageously detects an environment-specific property and/or a property relating to an external application unit, and provides a parameter that relates to the environment and/or to the external application unit.

An “environment property” shall be understood to mean here in particular a property that defines an environment surrounding the sensor module. Said environment property, for example, may be in the form of an ambient pressure, an ambient temperature, an ambient noise level, an ambient gas parameter, an ambient gas concentration, an ambient moisture parameter, an ambient acidity and/or alkalinity parameter or another environment property considered practical by a person skilled in the art.

A property relating to an external application unit shall be understood to mean here in particular a property such as a rotational speed, a temperature, a torque, an impact energy, a feed rate, a current, a voltage, a vibration or the like or another property considered practical by a person skilled in the art.

In a preferred embodiment, the parameter relating to the environment and/or to the external application unit is transmitted to an open-loop and/or closed-loop control unit associated with the external application unit and/or to an external data processing unit.

If the parameter relating to the environment and/or to the external application unit is transmitted to an open-loop and/or closed-loop control unit associated with the external application unit, the open-loop and/or closed-loop control unit controls by open-loop and/or closed-loop means the external application unit on the basis of the sensor signal. It is thus possible that the open-loop and/or closed-loop control unit controls by open-loop and/or closed-loop means at least a rotational speed, a current, a voltage, a temperature or the like. If the parameter relating to the environment and/or to the external application unit is transmitted to an external data processing unit, the value of the parameter can be processed in the data processing unit particularly preferably as an electronic value.

In another advantageous embodiment, the parameter relating to the environment and/or to the external application unit is converted into at least a first parameter output, and transmitted from the communications module to an open-loop and/or closed-loop control unit associated with the external application unit and/or to an external data processing unit.

A “parameter output” shall be understood to mean here a digitized value of the parameter relating to the environment and/or to the external application unit. Thus a voltage can be output digitally as a value of the voltage. This digitized value of the parameter is advantageously transmitted from the communications module to the open-loop and/or closed-loop control unit associated with the external application unit and/or to the external data processing unit.

The sensor module advantageously comprises at least one data interface, which is provided in particular to transmit information from the communications module to an external data processing unit. The sensor module is preferably integrated into at least one of the external application units:
a. into a hand power tool
b. into an item of work equipment
c. into a tool
d. into a toolbox or a tool kit
e. into an item of clothing, in particular into protective work clothing
f. into a rechargeable battery
g. into an electrical appliance
h. into an electronic device and/or into a data processing unit
i. into a meter
j. into a production facility

In another advantageous embodiment, the sensor module comprises at least one information output unit. An information output unit for outputting information to an operator is preferably in the form of a visual, acoustic and/or haptic information output unit. Said information output unit is preferably part of the sensor module. It is also possible, however, that the information output unit is part of an external unit such as, for example, part of a smartphone, a tablet, a PC, a laptop or the like. The information output unit preferably comprises for outputting information to an operator at least one visual output unit such as, for example, an LC display, a touch-sensitive display, an LED display, a plasma display or the like, for outputting information visually to an operator. The information output unit preferably comprises at least one acoustic output unit such as, for example, a loudspeaker or the like, for outputting information acoustically to an operator. The information output unit particularly preferably comprises at least one haptic output unit such as, for example, a vibration excitation unit or the like, for outputting information haptically to an operator. Other forms of information output to an operator that are considered practical by a person skilled in the art are likewise possible.

The communications module advantageously sends data, in particular electronic data, to the external information output unit, and the external information output unit conveys in particular visual and/or acoustic and/or haptic information to an operator.

A communications module is advantageously provided particularly for use in a sensor module. Particularly preferably, the communications module exchanges data, in particular electronic data, with an external communications module.

Further advantages and advantageous embodiments can be found in the description of the figures and from the drawings.

### DRAWINGS

Exemplary embodiments of a plurality of variants of the sensor module according to the invention and of a plurality of external application units are shown in the drawings, in which:

FIG. 1 is a schematic diagram of variants of a sensor module according to the invention;

FIG. 1a is a schematic diagram of an embodiment of the sensor module;

FIG. 1b is a schematic diagram of a first embodiment of an electrical interface;

FIG. 1c is a schematic diagram of a second embodiment of an electrical interface;

FIG. 1d is a schematic diagram of a first embodiment of a mechanical interface;

FIG. 1e is a schematic diagram of a second embodiment of a mechanical interface;

FIG. 1f is a schematic diagram of a third embodiment of a mechanical interface;

FIG. 1g is a schematic diagram of a storage system for the sensor module;

FIG. 2 is a schematic diagram of a sensor module according to the invention having an embodiment of an external application unit;

FIG. 3 is a schematic diagram of a sensor module according to the invention having a second embodiment of the external application unit;

FIG. 4 is a schematic diagram of a sensor module according to the invention having a third embodiment of the external application unit;

FIG. 5 is a schematic diagram of a sensor module according to the invention having a fourth embodiment of the external application unit;

FIG. 6 is a schematic diagram of a sensor module according to the invention having a fifth embodiment of the external application unit;

FIG. 7 is a schematic diagram of a sensor module according to the invention having a sixth embodiment of the external application unit;

FIG. 8 is a schematic diagram of a sensor module according to the invention having a seventh embodiment of the external application unit;

FIG. 9 is a schematic diagram of a sensor module according to the invention having an eighth embodiment of the external application unit;

FIG. 10 is a schematic diagram of a first embodiment of a system according to the invention containing a sensor module;

FIG. 11 is a schematic diagram of a second embodiment of a system according to the invention containing a sensor module;

FIG. 12 is a schematic diagram of a third embodiment of a system according to the invention containing a sensor module.

### DESCRIPTION

The same reference numbers are used for the same components appearing in the different exemplary embodiments.

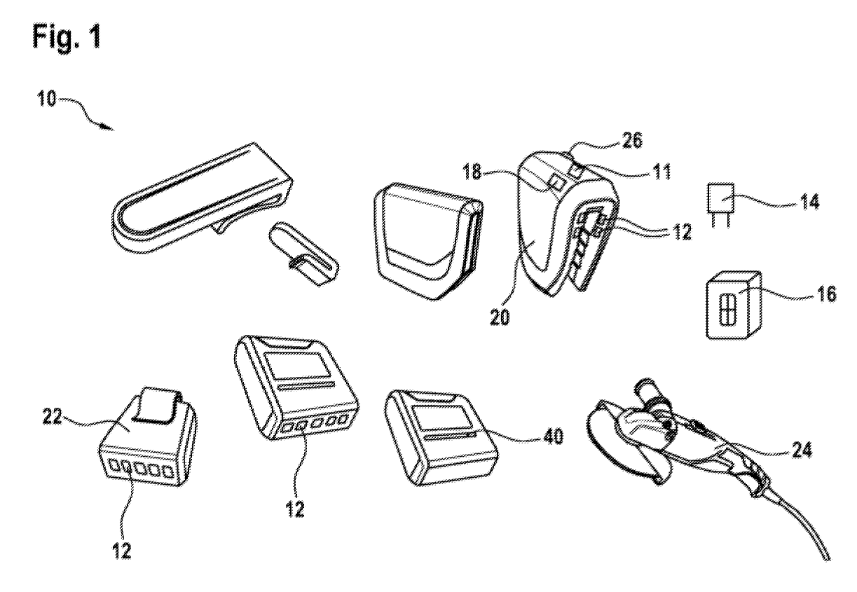

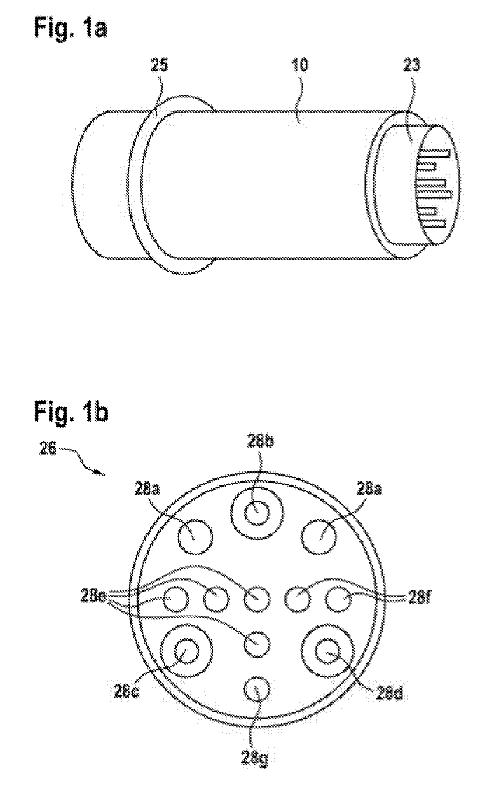

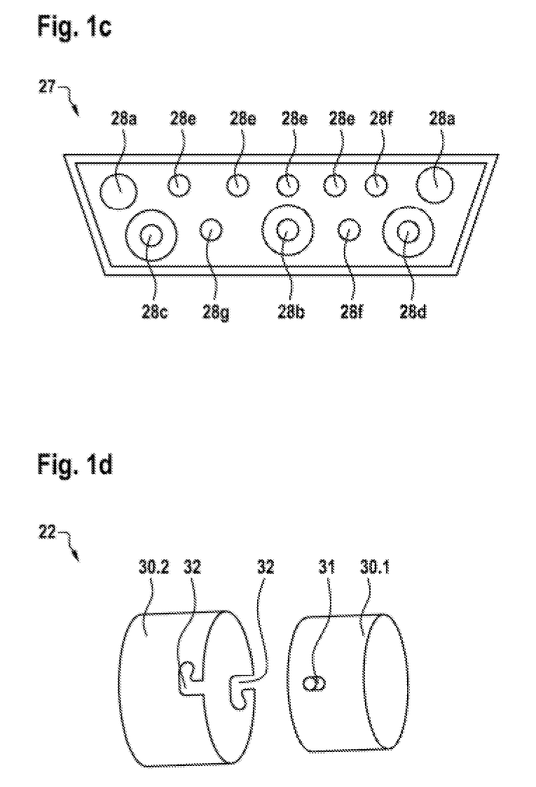

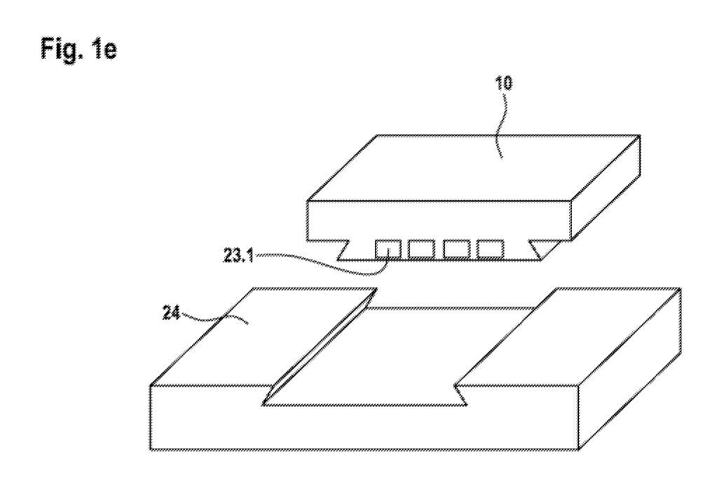

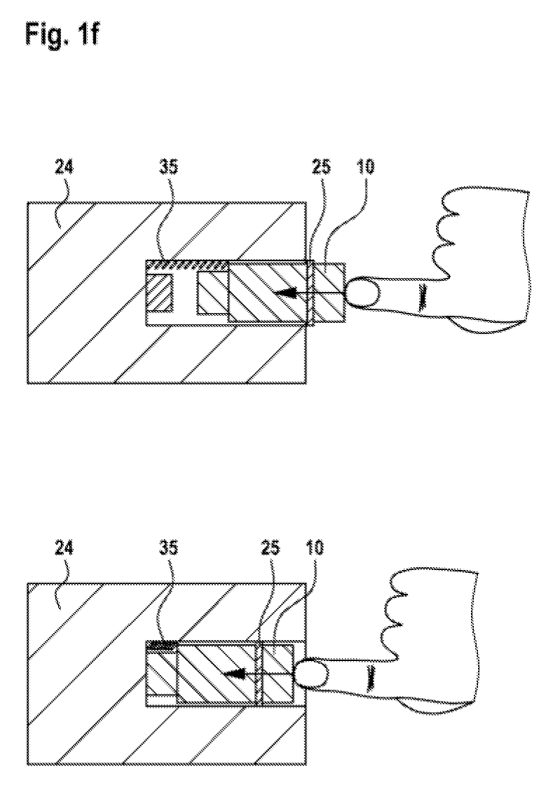

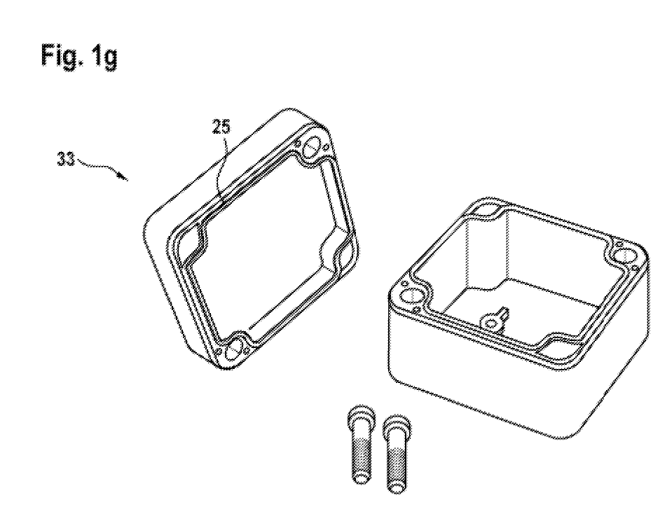

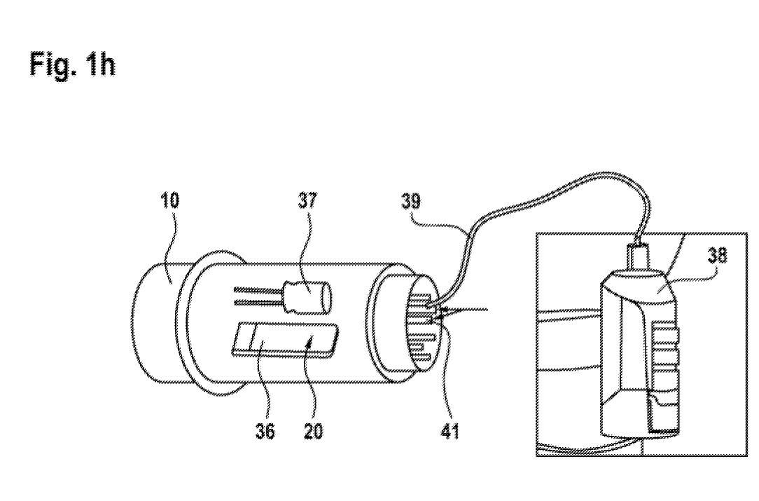

FIG. 1 shows a number of sensor modules 10 that have a variety of uses. A sensor module 10 is equipped with one or more sensors 11. The sensors are designed to detect one or more properties to be determined and to convert said properties into one or more sensor signals. The sensor module 10 is equipped with an electrical interface 12 or a plurality of electrical interfaces 12. The electrical interface 12 is designed to provide the sensor signal to an external open-loop and/or closed-loop control unit 14 and/or to an external data processing unit 16.

The service module 10 comprises a communications module 18 for establishing a data transmission connection.

A power supply unit 20 is preferably implemented as a rechargeable battery 20. The power supply unit 20 is designed to supply the sensor module 10 with electrical power.

The sensor module 10 also comprises a mechanical interface 22. The mechanical interface 22 is designed to connect the sensor module 10 detachably to various external application units 24. The advantage is that the sensor module 10 can be attached to various required external application units 24 and can therefore be versatile to use.

In the exemplary embodiment of FIG. 1a, the sensor module 10 is cylindrical in shape. A male contact 23 is designed to connect the sensor module 10 to an external application unit 24. A sealing element 25 is arranged on the outer face of the cylindrical body of the sensor module 10 in order to protect the sensor module 10 from moisture and/or dust.

In FIG. 1b, the electrical interface 12 is embodied as a circular combination male connector 26. In FIG. 1c, the electrical interface 12 is embodied as a rectangular combination male connector 27. The combination male connectors 26, 27 comprise at least one of the following connections 28:
two-pin connection 28a for the power supply, in particular 3.3V, preferably 5V, more preferably 12V
dual-conductor GPS antenna connection 28b
dual-conductor Bluetooth antenna connection 28c
dual-conductor WLAN antenna connection 28c
connections 28e for digital signal transmission
two-pin sensor connection 28f
connection 28g for coding

In FIG. 1d, the mechanical interface 22 is embodied as a bayonet catch 30. A first bayonet catch piece 30.1 comprises two diametrically opposite and outward-facing fastening pins 31. It is also possible, however, that there are more than or fewer than two fastening pins. A second bayonet catch piece 30.2 comprises two fastening slots 32 corresponding to the fastening pins.

In FIG. 1e, the mechanical interface is embodied as a slideway. A contact element 23.1 is designed to connect the sensor module 10 to an external application unit, for example to an electrical power tool.

It is also possible, however that the mechanical interface 22 is implemented as a clip, a screw coupling or the like, in order to produce an interlocking connection to an external application unit 24.

FIG. 1f shows the mechanical interface implemented by means of a spring connection 35. With the spring connection 35 released (top illustration), the sensor module 10 is detached from the external application unit 24. With the spring connection 35 clamped (bottom illustration), the sensor module 10 is connected to the external application unit 24.

FIG. 1g shows a storage system 33 for a sensor module 10. The sealing element 25 is here integrated in the storage system 33 so that the sensor module 10 is protected from moisture and/or dust when housed in the storage system 33.

FIG. 1h shows the sensor module 10 having an external power supply unit 38, which is connected to the sensor module 10 via a connecting element 39 having power supply terminals 41. In addition, an energy storage device 36 is built into the sensor module 10. The energy storage device 36 can be implemented as a rechargeable battery 20, a capacitor 37, a storage reactor or the like.

The sensor module 10 comprises a sensor 11, which detects an environment-specific property and/or a property relating to the external application unit 24, and provides a parameter that relates to the environment and/or to the external application unit 24.

The sensor module 10 here comprises at least one of the following sensors 11:
a displacement sensor 11, which is designed to detect at least one displacement property and provides a parameter characterizing the displacement property,
an accelerometer 11, which is designed to detect at least one acceleration property and provides a parameter characterizing the acceleration property,
a motion detector 11, which is designed to detect at least one motion property and provides a parameter characterizing the motion property,
a yaw-rate sensor 11, which is designed to detect at least one rotation property and provides a parameter characterizing the rotation property,
a pressure sensor 11, which is designed to detect at least one pressure property and provides a parameter characterizing the pressure property,
a moisture sensor 11, which is designed to detect at least one moisture property and provides a parameter characterizing the moisture property,
a gas sensor 11, which is designed to detect at least one gas property and provides a parameter characterizing the gas property,
an attitude sensor 11, which is designed to detect at least one attitude property and provides a parameter characterizing the attitude property,
a light sensor 11, which is designed to detect at least one light property and provides a parameter characterizing the light property,
an acoustic sensor 11, which is designed to detect at least one acoustic property and provides a parameter characterizing the acoustic property,
a temperature sensor 11, which is designed to detect at least one temperature property and provides a parameter characterizing the temperature property,
a magnetic field sensor 11, which is designed to detect at least one magnetic field property and provides a parameter characterizing the magnetic field property,
a GPS sensor 11, which is designed to detect at least one GPS property and provides a parameter characterizing the GPS property.

The parameter relating to the environment and/or to the external application unit 24 is transmitted to the open-loop and/or closed-loop control unit 14 associated with the external application unit 24 and/or to the external data processing unit 16.

It is also possible, however, that the parameter relating to the environment and/or to the external application unit 24 is converted into a parameter output, and transmitted from the communications module 18 to the open-loop and/or closed-loop control unit 14 associated with the external application unit 24 and/or to an external data processing unit 16.

The sensor module 10 comprises a data interface 34. The data interface 34 transmits a piece of information provided by the communications module 18 to the external data processing unit 16.

The sensor module 10 is integrated into one of the following external application units 24:
a. power hand tool 24a
b. item of work equipment 24b
c. tool 24c
d. toolbox 24d or tool kit
e. item of clothing 24e, in particular protective work clothing

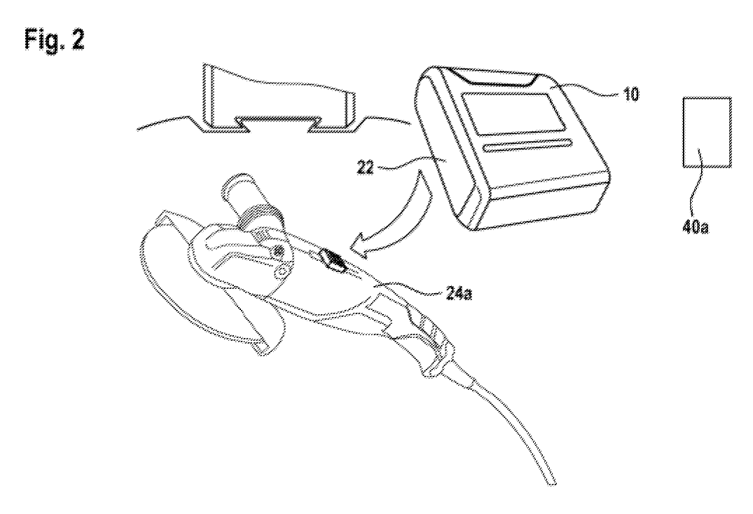

In FIG. 2, the external application unit 24 is embodied as a power hand tool 24a, in particular as an angle grinder.

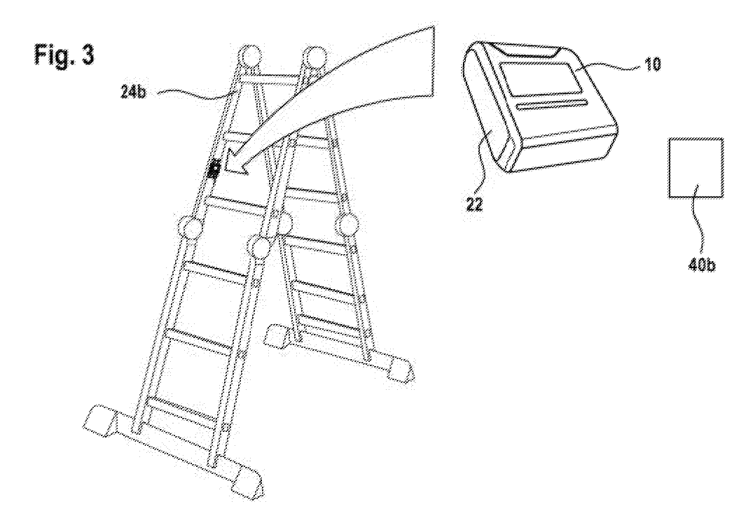

In FIG. 3, the external application unit 24 is embodied as an item of work equipment 24b, in particular as a ladder.

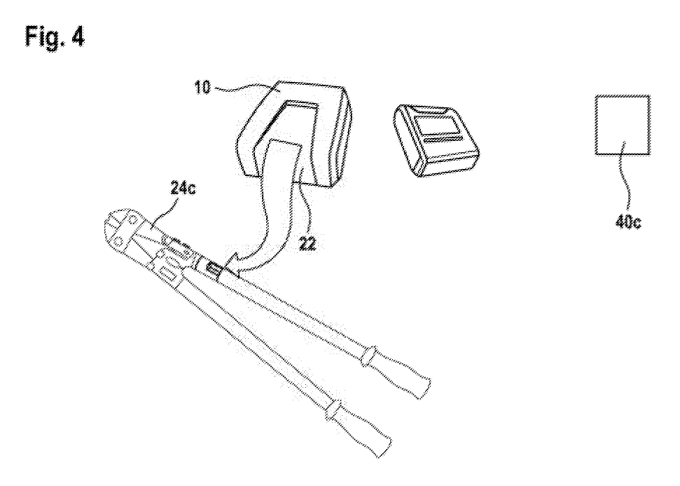

In FIG. 4, the external application unit 24 is embodied as a tool 24c, in particular as bolt cutters.

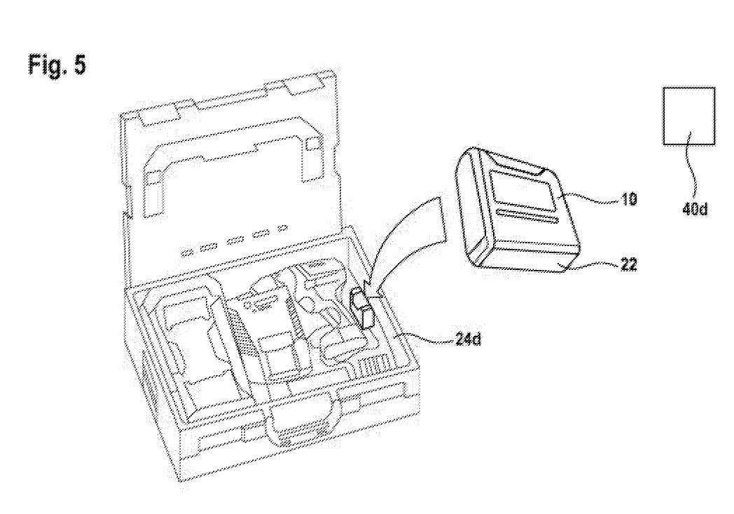

In FIG. 5, the external application unit 24 is embodied as a toolbox 24d. It is also possible, however, that the external application unit 24 is embodied as a tool kit.

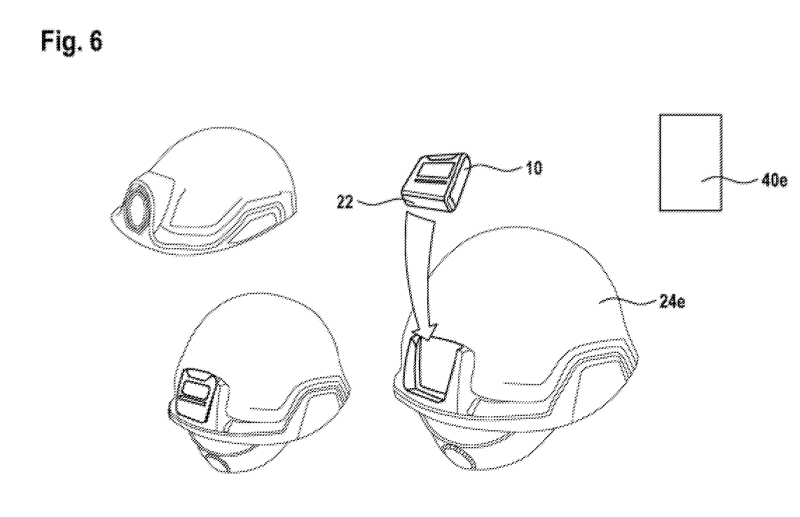

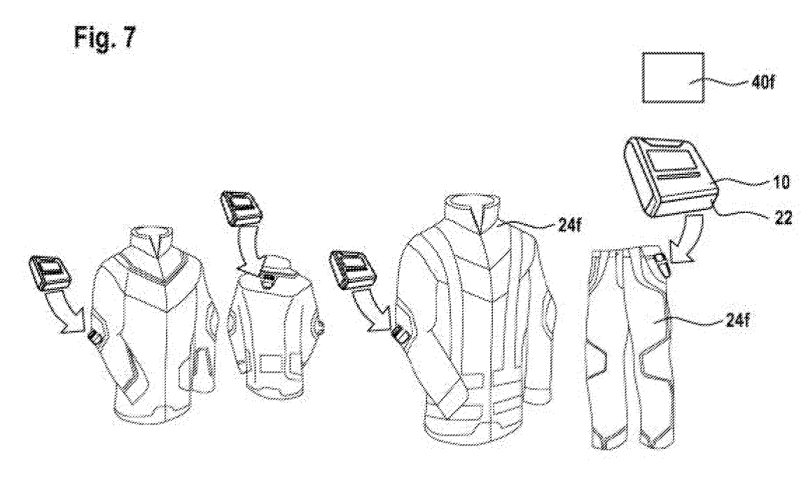

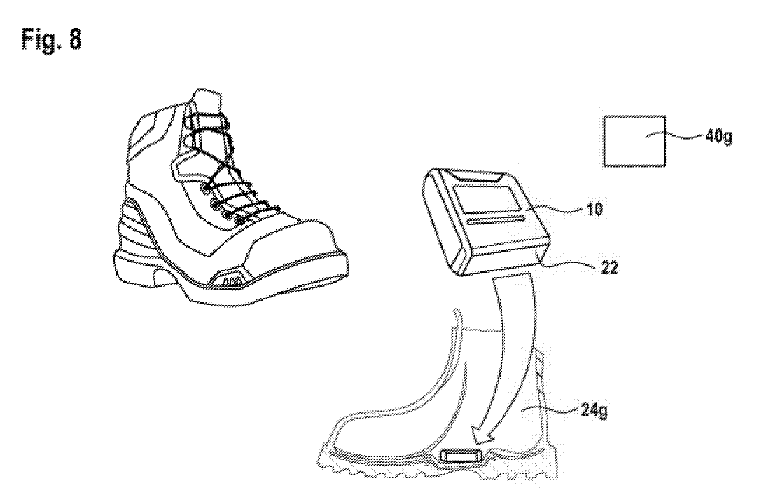

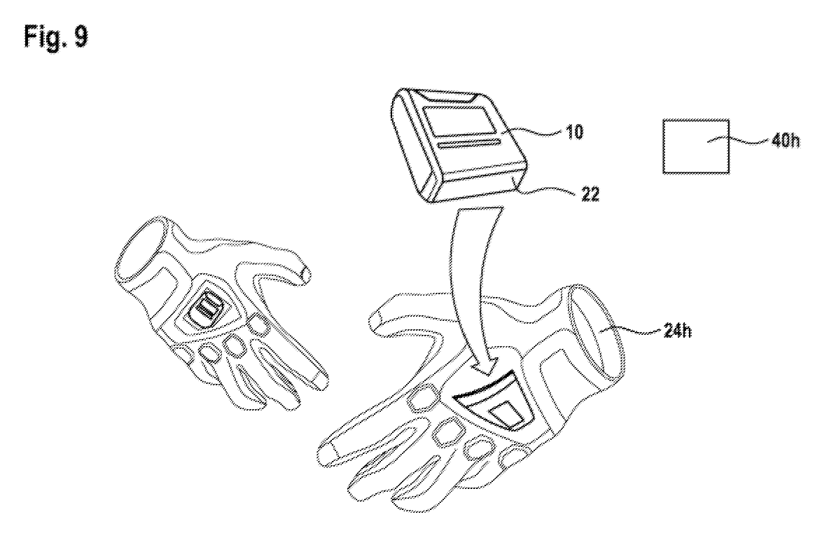

In FIGS. 6 to 9, the external application unit 24 is embodied as an item of clothing 24e, in particular as a helmet (FIG. 6), as a jacket (FIG. 7), as a pair of trousers (FIG. 7), as a boot (FIG. 8) or as a glove (FIG. 9).

The sensor module 10 comprises an information output unit 40, which conveys visual information to an operator. The environment-specific property and/or the property relating to the external application unit 24 can hence be displayed to the operator. Thus, for example, the operator of a power hand tool 24a can be provided with a visual display of the parameters relating to the power hand tool. It is also possible, however, that acoustic and/or haptic information is conveyed to the operator.

In an embodiment shown in figure to 9, the communications module 18 sends data that characterizes the environment-specific property and/or the property relating to the external application unit 24b to 24f to an external information output unit 40b to 40f, and the external information output unit 40b to 40f conveys visual and/or acoustic and/or haptic information to an operator.

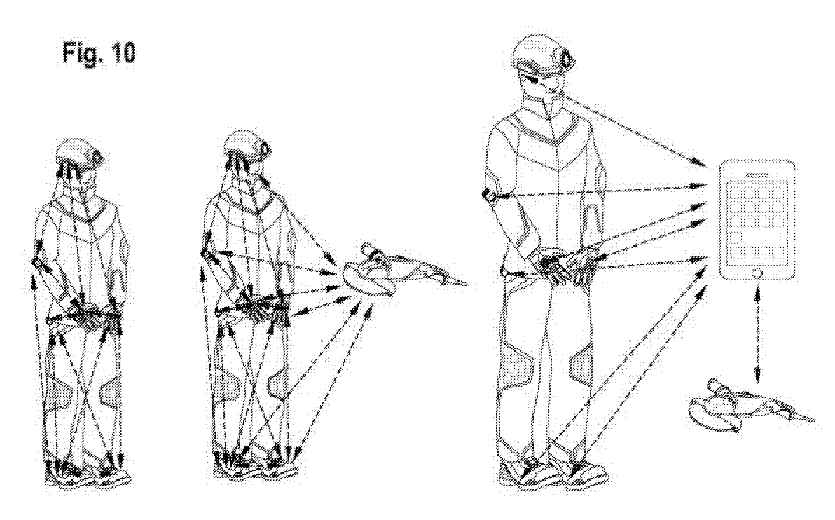

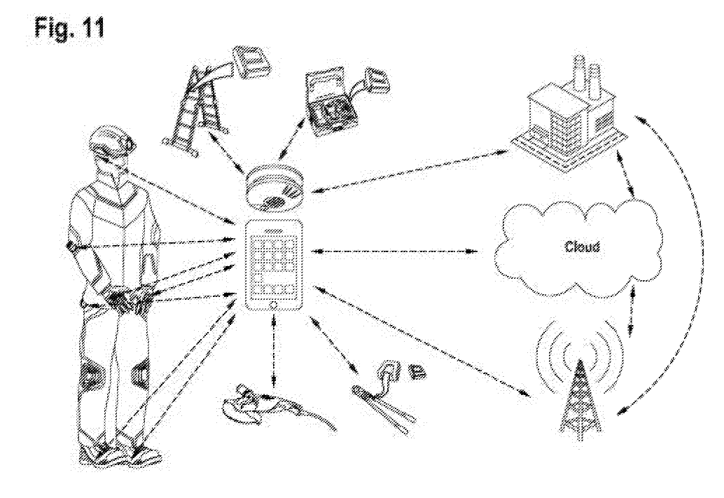

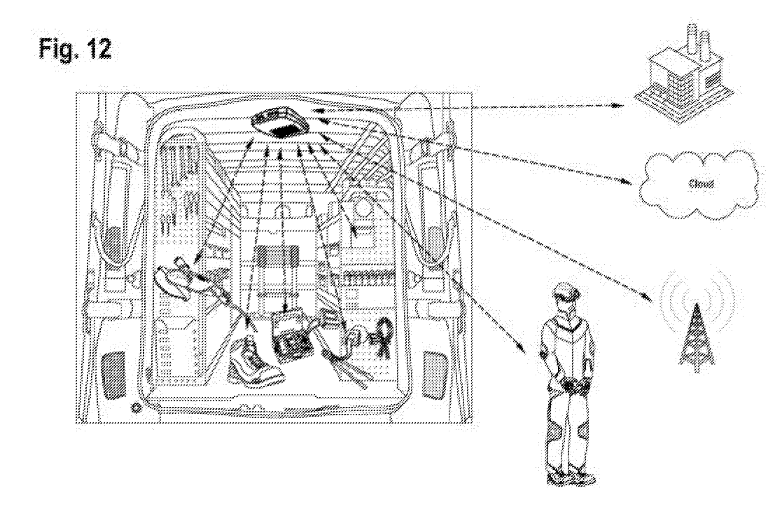

FIGS. 10 to 12 show an interconnection between the sensor module 10 and various external application units 24.

1. A sensor module configured for use in a system, comprising:
at least one sensor configured to detect and convert at least one parameter to be determined into a sensor signal;
at least one communications module configured to establish a data transmission connection;
at least one power supply unit configured to supply the sensor module with electrical power; and
at least one mechanical interface wherein the sensor module is further configured to be connected to external application units using the at least one mechanical interface.

2. The sensor module as claimed in claim 1, wherein the at least one sensor is further configured to detect at least one of: (i) an environment-specific property or (ii) a property relating to at least one external application unit of the external application units, and
wherein the at least one sensor is further configured to provide a parameter that relates to at least one of (i) environment or (ii) the at least one external application unit.

3. The sensor module as claimed in claim 2, wherein the parameter relating to at least one of (i) the environment or (ii) the at least one external application unit is transmitted to at least one of (i) an open-loop and/or closed-loop control unit associated with the at least one external application unit or (ii) an external data processing unit.

4. The sensor module as claimed in claim 2, wherein the parameter relating to at least one of (i) the environment or (ii) the at least one external application unit is converted into at least a first parameter output, and is transmitted from the at least one communications module to at least one of (i) an open-loop and/or closed-loop control unit associated with the at least one external application unit or (ii) an external data processing unit.

5. The sensor module as claimed in claim 1, further comprising:
at least one data interface configured to transmit information from the at least one communications module to an external data processing unit.

6. The sensor module as claimed in claim 1, wherein the sensor module is further configured to be integrated into at least one of the external application units, the external application units including at least one of a power hand tool, an item of work equipment, a tool, a toolbox or a tool kit, and an item of clothing.

7. The sensor module as claimed in claim 1, further comprising:
at least one information output unit configured to convey information to an operator.

8. The sensor module as claimed in claim 7, wherein the at least one communications module is configured to provide data to an external information output unit and the external information unit is configured to convey information to an operator.

9. A communications module configured to be operable in a sensor module, wherein the sensor module is configured for use in a system, the sensor module comprising:
at least one sensor configured to detect and convert at least one parameter to be determined into a sensor signal;
at least one communications module configured to establish a data transmission connection;
at least one power supply unit configured to supply the sensor module with electrical power; and
at least one mechanical interface,
wherein the sensor module is further configured to be connected to external application units using the at least one mechanical interface, and
wherein the communications module is configured to exchange data with an external communications module.

10. A system comprising:
at least one sensor module;
at least one sensor configured to detect and convert at least one parameter to be determined into a sensor signal;
at least one communications module configured to establish a data transmission connection;
at least one power supply unit configured to supply the sensor module with electrical power; and
at least one mechanical interface wherein the sensor module is configured to be connected to external application units using the at least one mechanical interface.

11. The sensor module as claimed in claim 1, wherein the sensor module is further configured to be connected detachably to the external application units.

12. The sensor module as claimed in claim 4, wherein the at least one data interface is further configured to transmit information from the at least one communications module to an external data processing unit.

13. The sensor module as claimed in claim 6, wherein the item of clothing is a protective work clothing.

14. The sensor module as claimed in claim 7, wherein the at least one information output unit conveys at least one of: (i) visual, (ii) acoustic, and (iii) haptic information to the operator.

15. The sensor module as claimed in claim 8, wherein the external information unit conveys at least one of: (i) visual, (ii) acoustic, and (iii) haptic information to the operator.
